(19) United States
(12) Patent Application Publication
(10) Pub. No.: US 2025/0129759 A1
(43) Pub. Date: Apr. 24, 2025

(54) Pulse Free Fuel Pump Device and Method of Use

(71) Applicant: David Allison, Clifton, TX (US)

(72) Inventor: David Allison, Clifton, TX (US)

(21) Appl. No.: 18/918,184

(22) Filed: Oct. 17, 2024

Related U.S. Application Data
(60) Provisional application No. 63/592,599, filed on Oct. 24, 2023.

(51) Int. Cl. F02M 59/16; F02M 59/12

(52) U.S. Cl. CPC F02M 59/16; F02M 59/12; F02M 37/20

(57) ABSTRACT

A pulse free fuel pump device designed to provide smooth, continuous fuel flow without pressure pulses is disclosed. The device includes a housing, a first impeller operating at a relatively low RPM to initiate fuel pressurization, and a second impeller operating at a relatively higher RPM to achieve final high pressure. A stator is positioned between the impellers to stabilize the fuel flow, and a rotor, connected to both impellers via a shaft provides synchronized rotation and reduces pulsation. The device is integrated into a fuel system comprising a fuel tank, a fuel filter, and a high-pressure fuel rail distributing fuel to injectors. The method of operation involves installing the pump in the fuel supply line, connecting it to the turbine's electrical system, and dynamically controlling rotor speed based on fuel demand, ensuring consistent, pulse-free fuel delivery to the combustion chamber.

### CROSS-REFERENCE TO RELATED APPLICATION

The present application claims priority to, and the benefit of, U.S. Provisional Application No. 63/592,599 which was filed on Oct. 24, 2023 and is incorporated herein by reference in its entirety.

### FIELD OF THE INVENTION

The present invention generally relates to the field of fuel delivery systems for internal combustion engines. More specifically, the present invention relates to a pulse free fuel pump device designed to provide smooth, continuous, and pulse-free fuel flow for high-pressure and high-temperature applications. The device includes a dual-impeller system with a stabilizing stator, driven by a dynamically controlled rotor to ensure consistent fuel delivery. The system effectively prevents vapor lock and minimizes energy consumption, offering a reliable and efficient fuel supply solution for modern engines. Accordingly, the present disclosure makes specific reference thereto. Nonetheless, it is to be appreciated that aspects of the present invention are also equally applicable to other like applications, devices, and methods of manufacture.

### BACKGROUND

By way of background, fuel delivery systems in both low and high-pressure applications often utilize impeller-based pumps to pressurize and move fuel within an engine. Conventional fuel delivery systems while effective in generating the necessary fuel pressure, can be inefficient due to the considerable amount of fuel required to rotate the impellers. The inefficiency is particularly pronounced in high-pressure systems where the impellers must operate at very high speeds to achieve the desired fuel pressure.

One of the issues associated with the conventional impeller-based fuel systems is vapor lock where the fuel vaporizes within the fuel lines or pump, causing a disruption in fuel flow to the engine. Vapor lock is more likely to occur on warm days when engine temperatures are elevated, exacerbating the problem. In engines with fuel pumps mounted directly on or near the engine, the heat from the engine can cause the fuel to reach its boiling point, leading to vapor lock and engine stalling.

Traditional fuel pumps often generate pulses due to the nature of their operation. Pulses can contribute to the formation of vapor pockets within the fuel system, increasing the likelihood of vapor lock. As a result, individuals desire a pulse-free fuel delivery method that can maintain a consistent and smooth fuel flow.

Therefore, there exists a long-felt need in the art for a fuel pump system that can provide reliable and continuous fuel delivery to engines such as in high-pressure and high-temperature environments. There is also a long-felt need in the art for a fuel delivery solution that minimizes inefficiencies by reducing the significant energy consumption associated with rotating impellers in traditional pumps. Additionally, there is a long-felt need in the art for a system that effectively prevents vapor lock. Moreover, there is a long-felt need in the art for a fuel pump system that can eliminate pressure pulses, thereby ensuring a smooth and consistent fuel flow to the engine. Furthermore, there is a long-felt need in the art for a dynamically adaptable fuel pump that can adjust its performance based on engine demand, optimizing fuel delivery under varying conditions. Finally, there is a long-felt need in the art for an innovative fuel pump design that offers a reliable, efficient, and adaptable solution to the challenges faced by traditional fuel pumps.

The subject matter disclosed and claimed herein, in one embodiment thereof, comprises a pulse free fuel pump device designed to address these long-standing challenges in fuel delivery systems. The device includes a dual-impeller setup with a stator positioned between the impellers to ensure a stabilized and pulse-free fuel flow. The first impeller operates at a lower RPM to begin the fuel pressurization process, while the second impeller, operating at a higher RPM, further increases the pressure to the levels required for high-powered engines. A specialized rotor drives both impellers synchronously and is designed with curved or helical blades to reduce pulsations.

In this manner, the pulse free fuel pump device of the present invention accomplishes all of the foregoing objectives and provides a novel fuel pump technology device that eliminates pressure pulses and prevents vapor lock. The device has a dual-impeller design which is combined with a stabilizing stator to deliver a smooth and continuous fuel flow that enhances engine performance and longevity. The Pulse Free Fuel Pump uses two impellers in its design, which is an improvement from the more conventional single-impeller setups. The impellers work together to ensure that the fuel flow is consistent and pulse-free. The device is designed to be adaptable for both low-pressure and high-pressure applications, providing an efficient and pulse-free alternative to traditional fuel pumps.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pulse free fuel pump device. The device comprises a housing configured to protect internal components of the pump device, a first impeller positioned within the housing, wherein the first impeller is adapted to begin the process of pressurizing fuel and initiate a smooth flow, the first impeller has blades with wider gaps therebetween to increase the volume of fuel moved at a lower rotational speed, a second impeller is positioned downstream of the first impeller, wherein the second impeller is adapted to further increase fuel pressure, the second impeller operates at a higher rotational speed than the first impeller and has blades with narrower gaps therebetween to achieve higher pressure. A stator is disposed between the first impeller and the second impeller, wherein the stator stabilizes the fuel flow as it passes between the two impellers. A rotor is configured to rotate and drive both the first and second impellers.

In yet another embodiment, a fuel pump device for delivering pulse-free fuel to a combustion engine is disclosed. The device comprises a housing configured for placement within a fuel tank, a first impeller is disposed within the housing and is adapted to operate at low RPM to move a high volume of fuel with minimal pressure, wherein the first impeller is configured to create an initial fuel pressure. A second impeller is disposed within the housing downstream of the first impeller, wherein the second impeller is adapted to further pressurize the fuel to a higher pressure for high-powered engines and operates at a higher RPM than the first impeller. A shaft is connected to a rotor and both impellers, enabling synchronous rotation of the impellers.

In another embodiment, a method for operating a pulse free fuel pump device in a fuel system of a turbine engine is described. The method includes the steps of installing the pulse free fuel pump device in the fuel supply line between the fuel tank and the turbine's combustion chamber, connecting the pulse free fuel pump device to the turbine's electrical system to provide power for the rotor and impellers, operating the first impeller at a lower rotational speed to create initial fuel pressure and deliver high volume of fuel, passing the fuel through a stator to stabilize the flow before reaching the second impeller, and operating the second impeller at a higher rotational speed to further pressurize the fuel and deliver it at a consistent, pulse-free pressure to the turbine engine.

In still another embodiment, a fuel system for a turbine engine is disclosed. The fuel system includes a fuel tank configured to store fuel, a pulse free fuel pump device positioned inside the fuel tank, wherein the pulse free fuel pump device comprises a first impeller adapted to operate at a lower RPM to create initial fuel pressure, a second impeller adapted to operate at a higher RPM to further increase the fuel pressure, positioned downstream of the first impeller, a stator positioned between the first and second impellers to stabilize the fuel flow, a rotor configured to rotate the impellers synchronously. The system also includes a fuel filter connected to the outlet of the pulse free fuel pump device, a high-pressure fuel rail connected to the fuel filter and adapted to distribute pressurized fuel to fuel injectors, and one or more fuel injectors configured to inject the pressurized fuel into the turbine's combustion chamber.

In another aspect, the first impeller operates at a lower RPM to generate initial fuel pressure without excessive heat buildup, while the second impeller further increases pressure in a controlled manner. The gradual pressurization process helps maintain the fuel below its boiling point, preventing vapor lock.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of pulse free fuel pump device of the present invention in accordance with the disclosed structure;

FIG. 2 illustrates a perspective view showing flow of fuel inside the pulse free fuel pump device in accordance with one embodiment of the present invention;

FIG. 3 illustrates a perspective view showing how the fuel pump device is implemented with a fuel tank system in accordance with the disclosed structure;

FIG. 4 illustrates an exemplary fuel system showing use of the fuel pump device of the present invention for pressurizing fuel in accordance with the disclosed structure; and

FIG. 5 illustrates a flow chart depicting a process of use of the pulse free fuel pump device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fuel pump system that can provide reliable and continuous fuel delivery to engines such as in high-pressure and high-temperature environments. There is also a long-felt need in the art for a fuel delivery solution that minimizes inefficiencies by reducing the significant energy consumption associated with rotating impellers in traditional pumps. Additionally, there is a long-felt need in the art for a system that effectively prevents vapor lock. Moreover, there is a long-felt need in the art for a fuel pump system that can eliminate pressure pulses, thereby ensuring a smooth and consistent fuel flow to the engine. Furthermore, there is a long-felt need in the art for a dynamically adaptable fuel pump that can adjust its performance based on engine demand, optimizing fuel delivery under varying conditions. Finally, there is a long-felt need in the art for an innovative fuel pump design that offers a reliable, efficient, and adaptable solution to the challenges faced by traditional fuel pumps.

The present invention, in one exemplary embodiment, is a fuel system for a turbine engine. The fuel system includes a fuel tank configured to store fuel, a pulse free fuel pump device positioned inside the fuel tank, wherein the pulse free fuel pump device comprises a first impeller adapted to operate at a lower RPM to create initial fuel pressure, a second impeller adapted to operate at a higher RPM to further increase the fuel pressure, positioned downstream of the first impeller, a stator positioned between the first and second impellers to stabilize the fuel flow, a rotor configured to rotate the impellers synchronously. The system also includes a fuel filter connected to the outlet of the pulse free fuel pump device, a high-pressure fuel rail connected to the fuel filter and adapted to distribute pressurized fuel to fuel injectors, and one or more fuel injectors configured to inject the pressurized fuel into the turbine's combustion chamber.

Reference will now be made in detail to the present preferred embodiments of the invention, examples of which are illustrated in the accompanying drawings. Wherever possible, the same reference numerals are used in the drawings and the description to refer to the same or like parts.

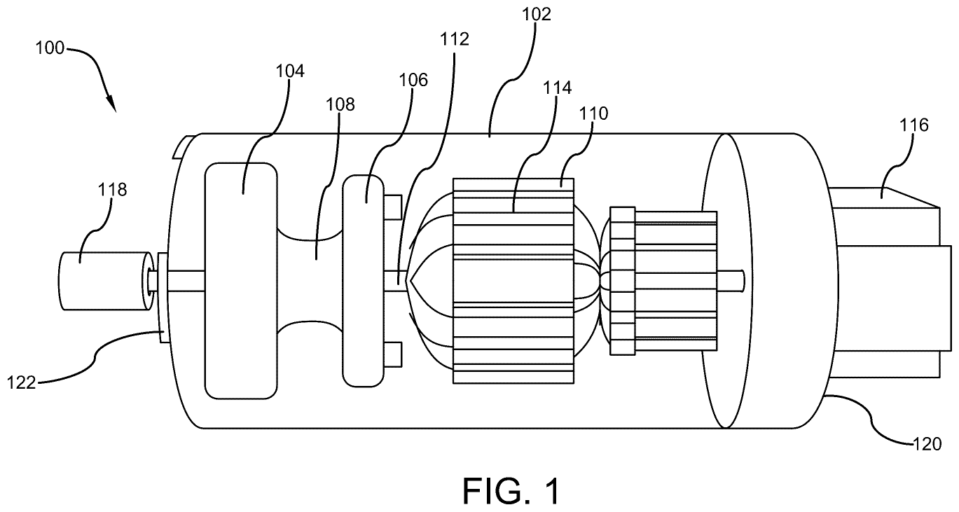

Referring initially to the drawings, FIG. 1 illustrates a perspective view of pulse free fuel pump device of the present invention in accordance with the disclosed structure. The pulse free fuel pump device 100 of the present invention is designed to provide a smooth, continuous fuel flow without the pressure pulses that are common in traditional pump designs. The pulse free fuel pump device 100 includes a housing 102 to protect the internal components of the fuel pump device 100 from physical damage. The fuel pump device 100 is preferably designed as an in-tank fuel pump device and is placed inside the fuel tank. In some embodiments, the fuel pump device 100 can also be designed as external fuel pump.

The pulse free high-pressure fuel delivery device 100 includes a first impeller 104. The first impeller 104 is designed to begin the process of pressurizing the fuel and initiating a smooth flow. A second impeller 106 is designed to further increase the fuel pressure to ensure the fuel is delivered at the required high pressure and pulse-free. The second impeller 106 is adapted to operate at a higher rotational speed than the speed of the first impeller 104 to achieve the final, higher pressure required for high-powered engines. A stator 108 is disposed between the two impellers 104, 106 and the stator 108 helps in stabilizing the flow of fuel, ensuring that when the fuel reaches the second impeller 106, the fuel is in an optimal state for further pressurization.

A specialized pump rotor 110 is included in the pulse free high-pressure fuel delivery device 100 to reduce the pulsation in the fuel flow. The rotor 110 rotates and helps to distribute the fuel evenly across the impellers 104, 106, thereby minimizing fluctuations in pressure. The rotor 110 is preferably cylindrical and closely fits within the pump housing 102 to maintain precise control over the fuel flow. The rotor 110 is made from high-strength materials such as hardened steel, aluminum, or composite materials and can withstand the high rotational speeds and mechanical stress without deforming or wearing out prematurely.

The speed of the rotor 110 may be dynamically controlled based on engine demand, enabling the pump to deliver the right amount of fuel at the right pressure under varying conditions. The rotor 110 is connected to the impellers 104, 106 using a shaft 112 enabling both the impellers 104, 106 to rotate synchronously. The rotor 110 may include curved or helical blades 114 that help to smooth out the fuel flow, preventing the formation of pulses. Opposite connectors 116, 118 are disposed on opposite ends 120, 122 of the housing 102 for providing electrical connections to the fuel pump device 100.

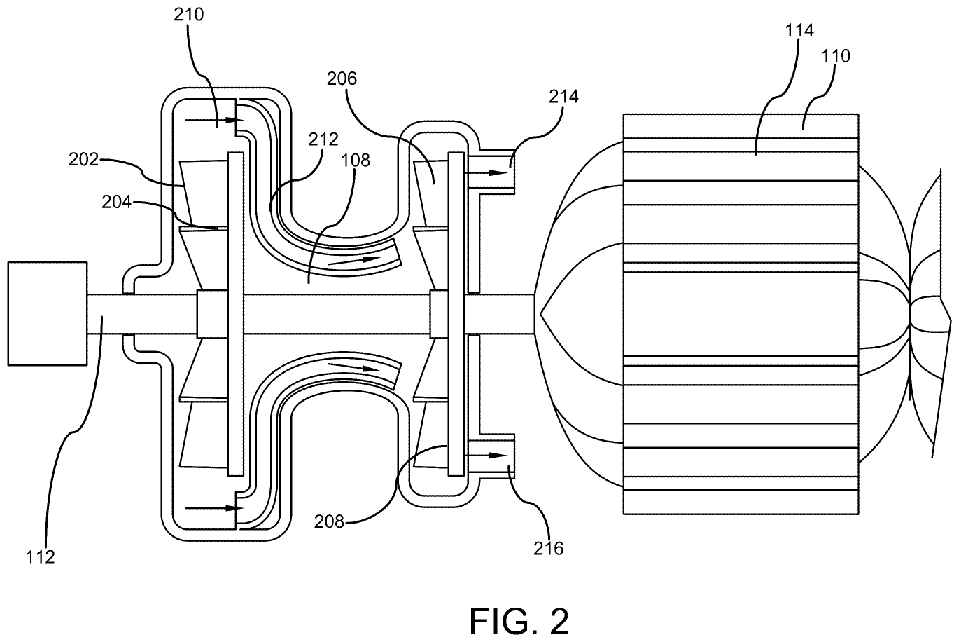

FIG. 2 illustrates a perspective view showing flow of fuel inside the dual-impeller pulse elimination fuel pump in accordance with one embodiment of the present invention. As illustrated, the first impeller 104 includes a plurality of blades 202 and the blades 202 have wider gaps 204 therebetween. The wider gap is adapted to increase the volume of fuel that can be moved by the first impeller 104 making it effective for low-pressure, high-volume fuel pumping. The first impeller 104 is designed to operate at a relatively lower rotational speed compared to the second impeller 106. The lower rotational speed enables the first impeller 104 to create the initial pressure without causing significant turbulence or pulsation. The second impeller 106 has narrower gaps 208 between the blades 206 thereof. The narrower gaps 208 provide finer control over the fuel and achieve higher pressure. The second impeller 106 provides higher pressure required for high-powered engines.

More specifically, in low-pressure applications where the pump device 100 operates at low revolutions per minute (RPM) and needs to deliver a high volume of fuel, the first impeller 104 is used to move a larger volume of fuel without the need for high pressure. For high-pressure applications, the pump device 100 utilizes the two impellers 104, 106 together similar to the design of a jet engine's turbine blades by rotation of the shaft 112. In high-pressure applications, the first impeller 104 generates half of the fuel pressure. The fuel then passes through the stationary stator 108 located between the two impellers 104, 106. The stator 108 smooths out the flow before the fuel enters the second impeller 106, which further increases the pressure and the pump delivers pulse-free fuel. The first impeller 104 operates at a lower RPM to generate initial fuel pressure without excessive heat buildup, while the second impeller 106 further increases pressure in a controlled manner to help maintain the fuel below its boiling point, preventing vapor lock.

The pressurized fuel 210 passes through the dual-impeller pulse elimination fuel pump 100 along the flow path 212 and exits through the exit ports 214, 216. The interaction between the impellers 104, 106, the rotor 110, and the stator 108 ensures that the fuel 210 is delivered at a consistent pressure without any pulses. The speed of the rotor 110 can be dynamically adjusted based on engine demand, which enables the pump to respond to varying conditions without overworking the system. The adaptability enables the pump to operate efficiently, thereby preventing the excessive heat generation that can lead to vapor lock.

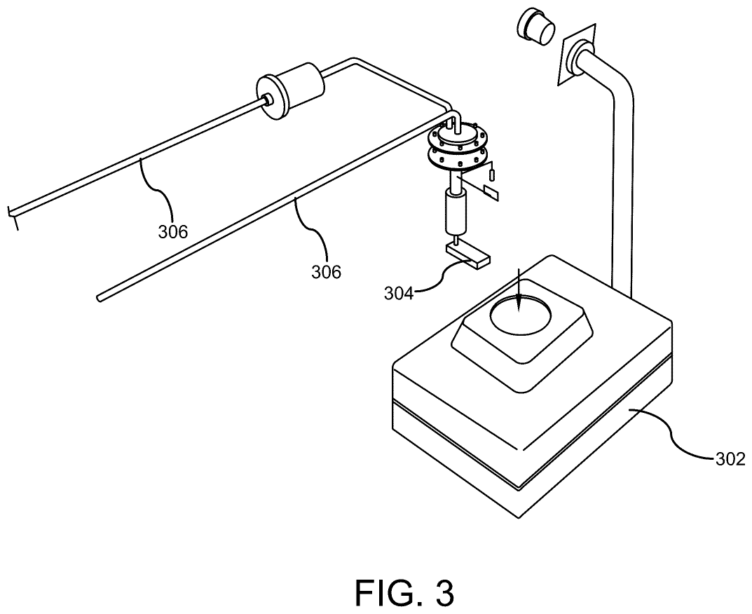

FIG. 3 illustrates a perspective view showing how the fuel pump device 100 is implemented with a fuel tank system in accordance with the disclosed structure. The fuel pump device 100 can be placed in a fuel tank 302 which is a container holding the fuel. The fuel pump 100 is adapted to draw fuel from the tank 302 and deliver the fuel to a fuel filter 304 to remove impurities. The fuel is transferred to one or more tubes 306 that carry fuel from the pump device 100 to other parts of the engine system of a vehicle. Depending on design of the fuel system of the vehicle, the pressurized fuel can be delivered to fuel injectors, which spray the fuel into the turbine's combustion chamber. The design of the fuel pump can depend on the type of fuel being used (e.g., gasoline, diesel, kerosene).

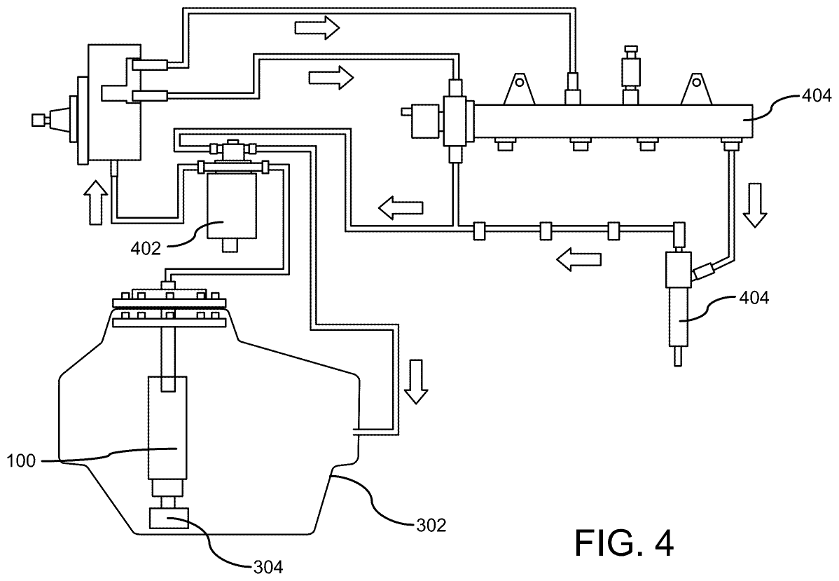

FIG. 4 illustrates an exemplary fuel system showing use of the fuel pump device of the present invention for pressurizing fuel in accordance with the disclosed structure. The pump device 100 is positioned inside the fuel tank 302 and the pump device 100 generates the high pressure required for fuel injection. The pump device 100 can generate fuel pressure between 1500 and 2500 bar. The pump device 100 is connected to a high-pressure fuel rail 402 that distributes the pressurized fuel to the individual injectors 404. Fuel injectors 404 are adapted to inject the fuel into the engine's combustion chambers and are electronically controlled and regulated by the electronic control unit of the vehicle.

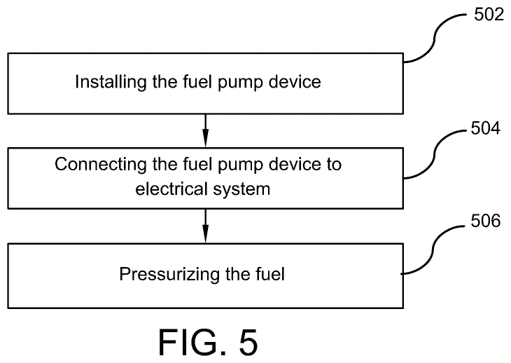

FIG. 5 illustrates a flow chart depicting a process of use of the pulse free fuel pump device of the present invention in accordance with the disclosed structure. Initially, the pump device 100 is installed in the fuel supply line, between the fuel tank and the turbine's combustion chamber (Step 502). The pump device 100 can be mounted within the turbine's engine compartment or fuel management area. Then, the pump device 100 is connected to the turbine's electrical system as the pump requires a stable power source to drive the rotor and impellers thereof (Step 504). Thereafter, based on the requirements, the impellers 104, 106 may work independently or in tandem for generating pressurized fuel for working of the fuel system of the vehicle (Step 506).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pulse free high-pressure fuel delivery device”, “dual-impeller pulse elimination fuel pump”, “pulse free fuel pump device” and “fuel pump device” are interchangeable and refer to the pulse free high-pressure fuel delivery device 100 of the present invention.

Notwithstanding the forgoing, the pulse free high-pressure fuel delivery device 100 of the present invention can be of any suitable size and configuration as is known in the art without affecting the overall concept of the invention, provided that it accomplishes the above stated objectives. One of ordinary skill in the art will appreciate that the pulse free high-pressure fuel delivery device 100 as shown in the FIGS. are for illustrative purposes only, and that many other sizes and shapes of the pulse free high-pressure fuel delivery device 100 are well within the scope of the present disclosure. Although the dimensions of the pulse free high-pressure fuel delivery device 100 are important design parameters for user convenience, the pulse free high-pressure fuel delivery device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pulse free high-pressure fuel delivery device comprising:
a housing;
a first impeller;
a second impeller;
a stator;
a pump rotor; and
a shaft;
wherein said first impeller initiates a first pressurizing of fuel;
wherein said second impeller initiates a second pressurizing of fuel;
wherein said second pressurizing of fuel is higher than said first pressurizing of fuel;
wherein said first impeller having a first rotational speed;
wherein said second impeller having a second rotational speed;
wherein said second rotational speed is higher than said first rotational speed; and
further wherein said stator positioned between said first propeller and said second propeller.

2. The pulse free high-pressure fuel delivery device of claim 1, wherein said pump rotor is cylindrical.

3. The pulse free high-pressure fuel delivery device of claim 2, wherein said housing houses said first impeller, said second impeller, said stator, said pump rotor, and said shaft.

4. The pulse free high-pressure fuel delivery device of claim 3, wherein said pump rotor connected to said first impeller and said second impeller with said shaft.

5. The pulse free high-pressure fuel delivery device of claim 4, wherein said first impeller and said second impeller rotate synchronously.

6. The pulse free high-pressure fuel delivery device of claim 5, wherein said pump rotor having helical blades.

7. The pulse free high-pressure fuel delivery device of claim 6, wherein said housing having a first electrical connector at a first end of said housing and a second electrical connector at an opposing second end of said housing.

8. The pulse free high-pressure fuel delivery device of claim 7, wherein said first impeller having a first plurality of blades including a first gap between each of said first plurality of blades.

9. The pulse free high-pressure fuel delivery device of claim 8, wherein said second impeller having a second plurality of blades including a second gap between each of said second plurality of blades.

10. The pulse free high-pressure fuel delivery device of claim 9, wherein said first gap is greater than said second gap.

11. The pulse free high-pressure fuel delivery device of claim 10, wherein said stator is stationary.

12. The pulse free high-pressure fuel delivery device of claim 11, wherein said second impeller having a pair of exit ports.

13. A fuel pump contained in a fuel tank comprising:
a fuel pump having a housing surrounding a first impeller, a second impeller, a stator, a pump rotor, and a shaft;
wherein said first impeller initiates a first pressurizing of fuel;
wherein said second impeller initiates a second pressurizing of fuel;
wherein said second pressurizing of fuel is higher than said first pressurizing of fuel;
wherein said first impeller having a first rotational speed;
wherein said second impeller having a second rotational speed;
wherein said second rotational speed is higher than said first rotational speed;
wherein said stator positioned between said first propeller and said second propeller; and
further wherein said fuel pump draws fuel from said fuel tank and deliver the fuel to a fuel filter.

14. The fuel pump contained in a fuel tank of claim 13, wherein said pump rotor connected to said first impeller and said second impeller with said shaft.

15. The fuel pump contained in a fuel tank of claim 13, wherein said first impeller and said second impeller rotate synchronously.

16. The fuel pump contained in a fuel tank of claim 13, wherein said pump rotor having helical blades.

17. The fuel pump contained in a fuel tank of claim 13, wherein said first impeller having a first plurality of blades including a first gap between each of said first plurality of blades, wherein said second impeller having a second plurality of blades including a second gap between each of said second plurality of blades, and further wherein said first gap is greater than said second gap.

18. A method of pumping fuel with a fuel pump, the method comprising the steps of:
providing a fuel pump having a housing surrounding a first impeller, a second impeller, a stator, a pump rotor, and a shaft;
initiating a first pressurizing of the fuel with said first impeller;
initiating a second pressurizing of the fuel with said second impeller, wherein said second pressurizing of fuel is higher than said first pressurizing of fuel, wherein said first impeller having a first rotational speed, wherein said second impeller having a second rotational speed, further wherein said second rotational speed is higher than said first rotational speed;
positioning said stator between said first propeller and said second propeller; and
drawing the fuel from a fuel source with said fuel pump.

19. The method of pumping fuel with a fuel pump of claim 18, wherein said pump rotor connected to said first impeller and said second impeller with said shaft.

20. The method of pumping fuel with a fuel pump of claim 18, wherein said first impeller having a first plurality of blades including a first gap between each of said first plurality of blades, wherein said second impeller having a second plurality of blades including a second gap between each of said second plurality of blades, and further wherein said first gap is greater than said second gap.
